(19) United States
(12) Patent Application Publication
(10) Pub. No.: US 2008/0091521 A1
(43) Pub. Date: Apr. 17, 2008

(54) SUPPLEMENTAL DISPLAY MATCHING USING SYNDICATION INFORMATION

(75) Inventors: Edward Ho, San Jose, CA (US); Pasha Sadri, Menlo Park, CA (US); Jonathan James Trevor, Santa Clara, CA (US); Daniel Joseph Raffel, San Francisco, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/550,307

(22) Filed: Oct. 17, 2006

(51) Int. Cl. G07G 1/14; G06F 17/30; G06F 17/00

(52) U.S. Cl. 705/14; 707/1; 715/234; 715/255

(57) ABSTRACT

Supplemental content is determined relative to web page content of a publisher web page, to display in association with the web page content. Syndication data is received regarding the content of the publisher web page. The syndication data is processed to cause determination therefrom of supplemental content to be displayed in association with the content of the publisher web page. An indication is provided of the determined supplemental content to display.

### BACKGROUND

It is known to display supplemental content, such as advertisements, on a published web page. As just one example, the Yahoo! Publisher Network is a service provided by Yahoo! Inc. of Sunnyvale, Calif., to enable web page publishers to have contextually-relevant advertisements displayed on their published web page. The web page publishers receive a portion of revenue generated by the advertisements (e.g., as a result of an advertisement being “clicked”).

The advertisements are typically determined as a result of a “crawling” process. During the crawling process, the published content of the web page is analyzed. As a result of the analysis, one or more advertisements from an inventory of advertisements is matched to the published content of the web page. When the web page is subsequently viewed, the advertisements determined as a result of the analysis are displayed in association with the published content of the web page.

### SUMMARY

Supplemental content is determined relative to web page content of a publisher web page, to display in association with the web page content. Syndication data is received regarding the content of the publisher web page. The syndication data is processed to cause determination therefrom of supplemental content to be displayed in association with the content of the publisher web page. An indication is provided of the determined supplemental content to display.

### BRIEF DESCRIPTION OF THE DRAWINGS

FIG. 1 illustrates an architecture of a system in which syndication data regarding the content of a published web page may be used to determined supplemental content to display in association with content of that published web page

FIG. 2 is a flowchart that broadly illustrates processing to accomplish causing the display of supplemental content in association with web page content.

### DETAILED DESCRIPTION

In accordance with an example, syndication data regarding the published content of a web page is used to determine supplemental content to display on that web page, in association with the published content. The act of publishing content to a webpage or blog may cause syndication data to be created providing an event indication that the web page content has been updated. This event in turn prompts a process of using the updated web page content to possibly determine different supplemental content to display on the web page in association with the updated published content.

In general, syndication data for a web page is data that represents the content of the web page and may even be identical in content to the content of the web page, but is not itself the content of the web page. The syndication data is available to syndication-aware programs that subscribe to a “feed” of the syndication data. The syndication data is typically designed to be machine-readable for efficient processing (e.g., into human-readable form). For example, the syndication data is typically XML-based or otherwise structured to ensure or enhance the machine-readability. A typical use of syndication data is by an aggregation program, which combines the contents of multiple feeds for display on a single screen or series of screens. Examples of syndication data include data formatted according to standards such as past, current and to-be promulgated versions of RSS and Atom. While RSS and Atom are popular syndication data formatting standards, there are (and, in high probability, will be) other standards for syndication data formatting.

In at least some examples, the syndication data 106 is determined and/or generated based on what the author and/or publisher of the web page content considers to be important. This may be done, for example, by an option of the same content management system that may be used to manually or automatically generate the web page content.

In accordance with one example, a “self-scraping” method is utilized to generate the syndication data. Thus, for example, scraping tools may process the web page content and extract what the tool deems to be the relevant parts, to include in the syndication data. Some scraping tools use regular expressions or XPath expressions. Other scraping tools process “hints” provided within the web page content, such as <div> or <span> tags, that help the scraping tool to decide what should be included in the syndication data. Alternately, some third parties may “scrape” the web page content and make the resulting syndication data generally available.

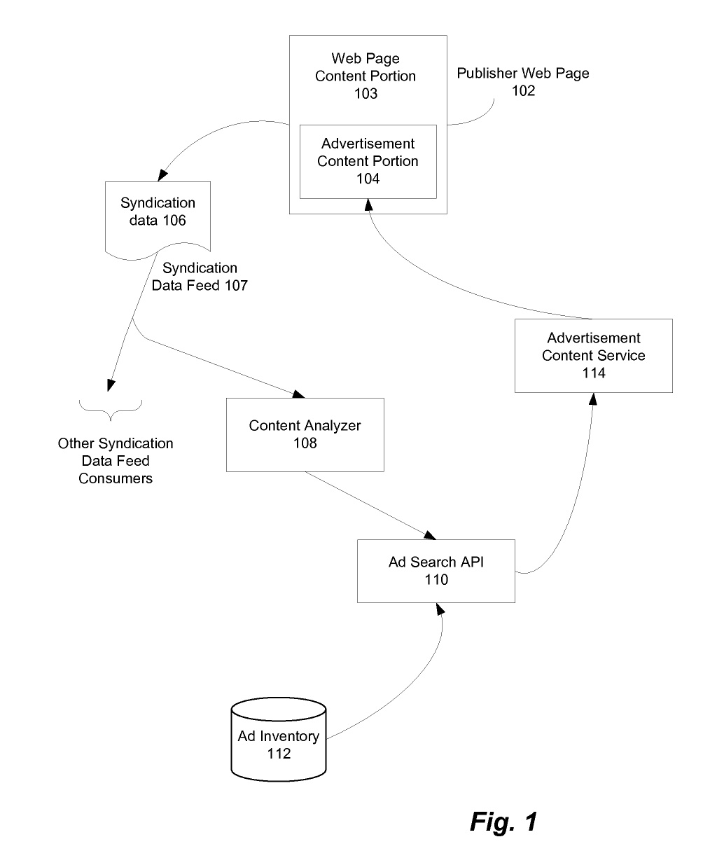

We now turn to FIG. 1, which illustrates an architecture of a system in which syndication data regarding the content of a published web page may be used to determine supplemental content to display in association with content of that published web page. As shown in FIG. 1, a publisher web page 102 (as rendered and displayed) includes a web page content portion 103 and an advertisement content portion 104. Advertisement content, caused to be displayed in the advertisement content portion 104, is provided from an advertisement content service 114. When the publisher web page 102 is caused to be displayed, the published content of the publisher web page is caused to be displayed in the web page content portion 103, and the associated advertisement content is caused to be displayed in the advertisement content portion 104.

More particularly, the associated advertisement content caused to be displayed in the advertisement content portion 104 is determined based on syndication data 106 that corresponds to the publisher web page content. As shown in FIG. 1, indicated by reference numeral 107 (“syndication data feed”), the syndication data 106 is provided in association with the publisher web page content. As discussed above, as a result of processing by syndication-aware programs, users can, for example, view the syndicated content 106. Furthermore, a program such as a feed reader or aggregator can check a list of feeds on behalf of a user and cause a display based on the syndication data 106 of the syndication data feed 107 and syndication data corresponding to other publisher web page content, such as causing the display of any articles that are found to have been updated.

In addition to the syndication data 106 being provided via the syndication data feed 107 for access by syndication-aware programs, a content analyzer 108 analyzes the syndication data 106 by accessing the syndication data feed 107. The analysis by the content analyzer 108 may be, for example, similar to the analysis that would otherwise be carried out on the published content during a crawling operation. The syndication data 106, typically structured, would generally be more easily processed than the web page content itself. In general, the syndication data is a cleaner representation of the web page content. For example, the syndication data typically does not include the navigation links of the web page.

In the discussion thus far, the supplemental content, caused to be displayed in association with the web page content, has been advertisement content. In accordance with other examples, the content caused to be displayed in association with the web page content is not advertisement content but, rather, is other content (such as, for example, a web badge, map, text ad, musical playlist, links, syndicated feed items, calendar with events, or other content) that has been determined based at least on the syndication data and that is available in association with the web page content.

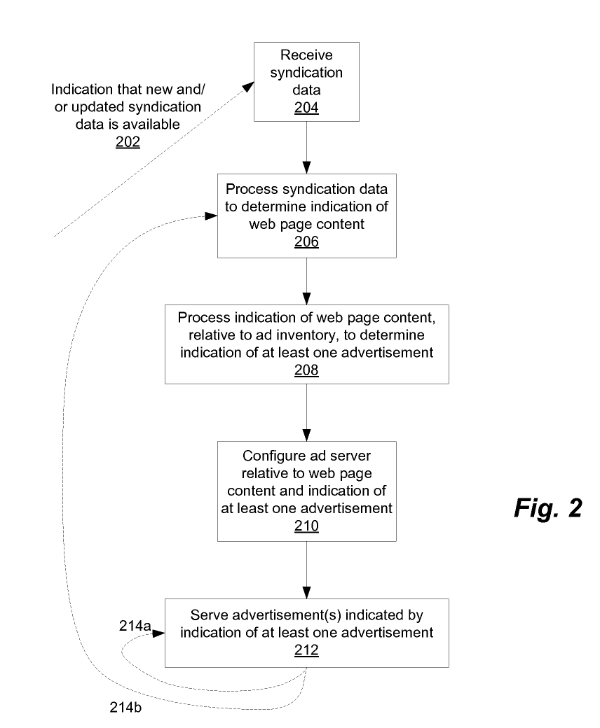

Having discussed the architecture illustrated in FIG. 1, we now discuss FIG. 2, which is a flowchart that broadly illustrates an example of processing to accomplish causing the display of supplemental content in association with web page content. The signal 202 is an indication that new and/or updated syndication data regarding the web page content is available. The signal 202 causes processing to go to step 204. It is noted that, in some examples, step 204 may be caused to be executed without regard for such a signal 202.

At step 204, syndication data is received regarding web page content. At step 206, the syndication data is processed to determine an indication of the web page content, such as a general or specific category of subject matter to which the web page content pertains. At step 208, the determined indication of the web page content is processed relative to an advertisement inventory, to determine an indication of advertising (which may even indicate no advertising). The advertisement service may have been configured, for example, as to how many advertisements to cause to indicate for the web page content and what types of advertisements to cause to display. The processing of step 208 may be informed by this configuration of the advertisement service.

The processing in step 208 indicated advertising to be displayed in association with the web page content. In some examples, the indication is a pointer that will point to a particular advertisement or particular advertisements that will be displayed, although it may not have been determined at the time of step 208 what is the particular advertisement or particular advertisements that will be displayed.

At step 210, the advertisement service (or, in the case of the supplemental content not being an advertisement, some other similar service) is configured relative to the web page content and to the indication of the advertising. For example, the advertisement service may be configured such that, when the web page content is caused to be displayed, the particular indicated advertisement is also caused to be displayed.

At step 212, the advertisement service serves the advertisements that the advertisement service has been configured to serve relative to the published content. Upon an indication 202 that new and/or updated syndication data is available, processing returns to step 204.

Arrow 214a indicates a request to display the published content. In accordance with the arrow 214 example, step 212 is repeated each time there is a request to display the published content. Arrow 214b illustrates another example, in which much of the FIG. 2 processing is “just in time” each time there is a request to display the published content. This may be useful, for example, for more closely personalizing the advertisements being displayed for a particular user based on characteristics of the requesting user and/or on past behavior of the particular user. As another example, it may be useful, as well, even for making an advertisement determination based on what advertisements have previously been caused to be displayed, for that user or otherwise. Arrows 214a and 214b are just examples, and other examples are possible as well.

We have described syndication data regarding the published content of a web page being used to determine supplemental content to display on that web page, in association with the published content. In general, the form of the syndication data is such that the supplemental content, including advertising, have increased relevance to a viewer of the web page.

What is claimed is:

1. A method of determining supplemental content relative to web page content of a publisher web page, to display in association with the web page content, comprising:
receiving syndication data regarding the content of the publisher web page;
processing the syndication data to cause determination therefrom of supplemental content to be displayed in association with the content of the publisher web page; and
providing an indication of the determined supplemental content to display.

2. The method of claim 1, wherein the indication of the determined supplemental content to display indicates no supplemental content to display.

3. The method of claim 1, wherein:
the supplemental content includes advertising;
processing the syndication data includes:
providing further processing of information from the syndication data to an advertisement matching service, wherein the advertisement matching service is caused to match the publisher web page content to advertising an inventory of advertisements, and
receiving the indication of advertising from the advertisement matching service.

4. The method of claim 3, wherein the received indication of advertising is an indication of no advertising.

5. The method of claim 1, further comprising:
receiving an indication that the syndication data regarding the content of the publisher web page has been adjusted; and
processing the indication by causing the adjusted syndication data to be processed, to cause the determination therefrom of supplemental content to be displayed in association with the content of the publisher web page.

6. A method of determining supplemental content relative to content of a publisher web page, to display in association with the web page content, comprising:
receiving an indication via a syndication protocol that the content of the publisher web page has been adjusted;
based at least in part on receiving the indication that the content of the publisher web page has been adjusted, causing determination of the supplemental content to be displayed in association with the adjusted content of the publisher web page; and
providing an indication of the determined supplemental content to be displayed in association with the content of the publisher web page.

7. The method of claim 6, wherein:
causing determination of the supplemental content to be displayed in association with the content of the publisher web page includes processing syndication data regarding the adjusted content of the publisher web page.

8. A computing device operable to perform the method of claim 1.

9. An apparatus to determine supplemental content relative to web page content of a publisher web page, to display in association with the web page content, comprising:
a syndication data receiver configured to receive syndication data regarding the content of the publisher web page;
a syndication data processor configured to process the syndication data to cause determination therefrom of supplemental content to be displayed in association with the content of the publisher web page; and
an indication provider configured to provide an indication of the determined supplemental content to display.

10. The apparatus of claim 9, wherein:
the indication provider is configured to selectively provide an indication of no supplemental content to display.

11. The apparatus of claim 9, wherein:
the supplemental content includes advertising;
the syndication data processor is configured to
provide information of the syndication data to an advertisement matching service, to cause the advertisement matching service to match the publisher web page content to advertising of an inventory of advertisements, and
receive the indication of the advertising from the advertisement matching service.

12. The apparatus of claim 11, wherein:
the syndication data processor is configured to selectively provide the indication of the advertising as an indication of no advertising.

13. The apparatus of claim 9, further comprising:
an adjustment indication receiver configured to receive an indication that the syndication data regarding the content of the publisher web page has been adjusted; and
an indication processor configured to process the indication by causing the adjusted syndication data to be processed, to cause the determination therefrom of supplemental content to be displayed in association with the content of the publisher web page.

14. An apparatus to determine supplemental content relative to content of a publisher web page, to display in association with the web page content, comprising:
an indication receiver configured to receive an indication via a syndication protocol that the content of the publisher web page has been adjusted;
a supplemental content determiner configured to, based at least in part on receiving the indication that the content of the publisher web page has been adjusted, cause determination of the supplemental content to be displayed in association with the adjusted content of the publisher web page; and
an indication provider configured to provide an indication of the determined supplemental content to be displayed in association with the content of the publisher web page.

15. The apparatus of claim 14, wherein:
the indication processor is further configured to process syndication data regarding the content of the publisher web page, to determine the supplemental content to be displayed in association with the content of the publisher web page.

16. A computer program product to determine supplemental content relative to web page content of a publisher web page, to display in association with the web page content, the computer program product comprising at least one computer-readable medium having computer program instructions stored therein which are operable to cause at least one computing device to:
receive syndication data regarding the content of the publisher web page;
process the syndication data to cause determination therefrom of supplemental content to be displayed in association with the content of the publisher web page; and
provide an indication of the determined supplemental content to display.

17. The computer program product of claim 16, wherein:
the indication of the determined supplemental content to display is an indication of no supplemental content to display.

18. The computer program product of claim 16, wherein:
the supplemental content includes advertising;
the computer program instructions operable to cause the at least one computing device to process the syndication data to include computer program instructions operable to cause the at least one computing device to:
provide information of the syndication data to an advertisement matching service, wherein the advertisement matching service is caused to match the publisher web page content to advertising of an inventory of advertisements, and
receive the indication of advertising from the advertisement matching service.

19. The computer program product of claim 18, wherein:
the computer program instructions operable to cause the at least one computing device to receive an indication of advertising are operable to cause the at least one computing device to receiving an indication of no advertising.

20. The computer program product of claim 16, wherein the computer program instructions further comprise computer program instructions operable to cause the at least one computing device to:
receive an indication that the syndication data regarding the content of the publisher web page has been adjusted; and
process the indication by causing the adjusted syndication data to be processed, to cause the determination therefrom of supplemental content to be displayed in association with the content of the publisher web page.

21. A computer program product for determining supplemental content relative to content of a publisher web page, to display in association with the web page content, the computer program product comprising at least one computer-readable medium having computer program instructions stored therein which are operable to cause at least one computing device to:
receive an indication via a syndication protocol that the content of the publisher web page has been adjusted;
based at least in part on receiving the indication that the content of the publisher web page has been adjusted, cause determination of the supplemental content to be displayed in association with the adjusted content of the publisher web page; and
provide an indication of the determined supplemental content to be displayed in association with the content of the publisher web page.

22. The computer program product of claim 21, wherein the computer program instructions operable to cause the at least one computing device to process the indication that the content of the publisher web page has been adjusted, the computer program product further comprising computer program instructions which are operable to cause the at least one computing device to:
process syndication data regarding the content of the publisher web page, to determine the supplemental content to be displayed in association with the content of the publisher web page.
